(19) United States
(12) Patent Application Publication
(10) Pub. No.: US 2023/0100152 A1
(43) Pub. Date: Mar. 30, 2023

(54) FEDERATED LEARNING ACCELERATORS AND RELATED METHODS

(71) Applicant: Intel Corporation, Santa Clara, CA (US)

(72) Inventors: Reshma Lal, Portland, OR (US); Nalini Kumar, Campbell, CA (US); Ruchika Singh, Chandler, AZ (US); Claire Vishik, Austin, TX (US)

(21) Appl. No.: 17/484,898

(22) Filed: Sep. 24, 2021

(51) Int. Cl. G06N 3/08; G06N 3/063

(52) U.S. Cl. CPC G06N 3/08; G06N 3/063

(57) ABSTRACT

Federated learning accelerators and related methods are disclosed. An example edge device includes neural network trainer circuitry to train a neural network to generate a model update for a machine learning model using local data; a federated learning accelerator to perform one or more federated learning workloads associated with the training; and model update provider circuitry to transmit the model update to an aggregator device.

### FIELD OF THE DISCLOSURE

This disclosure relates generally to machine learning and, more particularly, to federated learning accelerators and related methods.

### BACKGROUND

Federated learning is an artificial intelligence (AI) training process where a machine learning model is trained in a decentralized manner by the edge devices and/or edge servers using local data available at the respective devices and/or the servers. The training results from the individual devices and/or servers are aggregated to update the machine learning model while maintaining privacy of the local data associated with each of the devices and/or servers.

### BRIEF DESCRIPTION OF THE DRAWINGS

FIG. 1 is a block diagram of a first example system constructed in accordance with teachings of this disclosure to provide training of a neural network using federated learning

FIG. 2 is a block diagram of a second example system constructed in accordance with teachings of this disclosure to provide training of a neural network using federated learning.

FIG. 3 is a block diagram of an example implementation of an aggregator device including one or more federated learning (FL) accelerators and FL accelerator management circuitry that may be used with the first system of FIG. 1 and/or the second system of FIG. 2.

FIG. 4 is a block diagram of an example implementation of a training device including one or more federated learning accelerators and FL accelerator management circuitry that may be used with the first system of FIG. 1 and/or the second system of FIG. 2.

FIG. 5 is a block diagram of an example implementation of the FL accelerator management circuitry of FIGS. 3 and/or 4.

FIG. 6 is a communication flow diagram representing operations performed at the example aggregator device of FIG. 3 and/or the example training devices of FIG. 4.

FIG. 7 is a flowchart representative of example machine readable instructions that may be executed by example processor circuitry to implement the example FL accelerator management circuitry of FIGS. 3, 4, and/or 5.

FIG. 8 is a block diagram of an example processing platform structured to implement the example aggregator device of FIG. 3.

FIG. 9 is a block diagram of an example processing platform structured to implement the example training device of FIG. 4.

FIG. 10 is a block diagram of an example implementation of the processor circuitry of FIGS. 8 and/or 9.

FIG. 11 is a block diagram of another example implementation of the processor circuitry of FIGS. 8 and/or 9.

FIG. 12 is a block diagram of an example software distribution platform (e.g., one or more servers) to distribute software (e.g., software corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Machine learning workloads such as training a machine learning model using dataset(s) are computationally intensive and resource-intensive tasks. A machine learning accelerator (e.g., an artificial intelligence (AI) accelerator) is hardware to accelerate machine learning workloads.

Federated learning enables a model representing a neural network to be trained across edge systems using local data associated with the respective edge systems and without sharing data between the systems and/or otherwise centralizing the data. For instance, a machine learning model can be distributed from a central source (e.g., a cloud server) to edge devices. The edge devices perform training of the model locally (e.g., using local data associated with the edge devices) and provide the results of the training to the central source for aggregation, updating of the model, etc.

The distributed nature of federated learning introduces challenges that may not otherwise occur in a centralized machine learning environment, or an environment in which a machine learning model is trained using data stored at a central location such as a cloud. For example, the edge systems are often heterogeneous systems that have varying compute and memory resources. Further, heterogeneity can exist between the data associated with the respective edge systems that is used to train the models with respect to data formats, data types, data sparsity, volume of data, etc. For example, in the context of healthcare data, different data formats exist between patient records, X-ray images, etc. Further, some edge devices in the system may have several years of local data available for training (e.g., ten years of data) while other edge devices in the system may have a smaller volume of data (e.g., two years of data). Additionally, federated learning introduces operations that are different from operations associated with centralized learning. For instance, an edge device may encrypt or create embeddings of local data prior to using the data to train the model for privacy purposes (e.g., such as patient records in the context of healthcare data). Also, the edge device broadcasts or transmits updates to the model and/or other training results to the central source after training is complete.

Example systems, apparatus, and methods disclosed herein facilitate execution of federated learning operation(s) via a federated learning (FL) accelerator(s). In examples disclosed herein, the FL accelerator(s) perform one or more operations or workloads associated with distributed training of a machine learning model, thereby offloading the performance of such operations from general computing resources of the computing devices in an edge or cloud system. In some examples disclosed herein, the FL accelerator(s) are implemented at training devices in an edge system (e.g., edge devices) to facilitate performance of operations associated with the training at the individual devices. For instance, operations such as data preprocessing and/or encryption of local data to be used in the training and/or transmitting model updates generated as a result of training with the local data can be performed by FL accelerator(s) of the training device. In some examples disclosed herein, the FL accelerators are implemented at aggregator device(s) in the edge system (e.g., an edge server) or the cloud system to facilitate aggregation of model updates from the training devices and updating of the machine learning model using the aggregated parameters.

Examples disclosed herein address heterogeneity between devices and training data in a federated learning environment (e.g., an edge system) with respect to, for instance, computing and memory resources, data types, and data formats. As a result of offloading certain workloads to the FL accelerators, speeds at which repeated patterns of computation with respect to machine learning training are performed can be increased, thereby providing for improved efficiency with respect to performance and power consumption. Also, as a result of the use of the FL accelerators to perform certain workloads, general device computing resources (e.g., central processing resources) that would otherwise be used to perform the distributed training workloads are available to perform other tasks. Thus, examples disclosed herein prevent or substantially reduce negative impacts on performance of one or more devices in the edge system that may otherwise occur if the general computing resources were used for training. Further, example FL accelerators disclosed herein can address heterogeneity with respect to the local data associated with each training device that is used to train the model. Examples FL accelerators disclosed herein can provide for customized processing of the data for training based on data formats, data sparsity, data types, etc. Examples disclosed herein also improve efficiency with respect to aggregation of the model updates by offloading such operations to the FL accelerator(s).

Example FL accelerators disclosed herein can include hardware (e.g., FPGAs) that is external to a central processing unit (CPU) of a device. Additionally or alternatively, example FL accelerators disclosed herein can be CPU-based accelerators that increase performance of the CPU when performing FL operations. The location(s) of the example FL accelerators disclosed herein can be based on considerations such as power, cost, latency, data privacy, etc. Example FL accelerators can be implemented in a variety of edge environments (e.g., healthcare systems, autonomous vehicle systems) to increase efficiency in distributed machine learning training.

FIG. 1 is a block diagram of a first example system 100 constructed in accordance with teachings of this disclosure to provide training of a neural network using federated learning. The example system 100 includes a cloud server 102 in communication with a first edge server 104, a second edge server 106, and n^{th} edge server 108.

In the example of FIG. 1, the first edge server 104 is in communication with a first edge device 110, the second edge server 106 is in communication with a second edge device 112, and the n^{th} edge server 108 is in communication with an n^{th} edge device 114. The edge device(s) 110, 112, 114 can be implemented by a computing platform such as an Internet of Things (IoT) device (e.g., an IoT sensor), a smartphone, a personal computer, etc. The first edge device 110 can include one or more edge devices. Similarly, the second edge device 112 and the n^{th} edge device 114 can each be implemented by one or more edge devices. In some examples, the edge device(s) 110, 112, 114 can include hundreds, thousands, millions, etc. of edge devices as in, for example, an IoT system. The example edge devices 110, 112, 114 can be utilized by any type of entity such as, for example, a corporate institution, a healthcare provider, a government, an end user, an autonomous vehicle provider, etc. In the example of FIG. 1, the edges devices 110, 112, 114 collect data (e.g., sensor data). In some examples, the edge devices 110, 112, 114 transmit raw data to the corresponding edge servers 104, 106, 108, which process (e.g., filter) the data. In other examples, the edge devices 110, 112, 114 transmit processed (e.g., filtered) data to the corresponding edge servers 104, 106, 108.

In the example system 100 of FIG. 1, the cloud server 102 distributes a machine learning (ML) model 116 to each of the edge servers 104, 106, 108. The data collected by the edge devices 110, 112, 114 is used by the corresponding edge servers 104, 106, 108 to train the machine learning model 116. For example, the first edge server 104 uses data generated by the first edge device 110 to train the model 116 (but not data generated by the second edge 112 or the n^{th} edge device 114). The second edge server 106 uses data generated by the second edge device 112 to train the model 116 (but not data generated by the first edge device 110 or the n^{th} edge device 114). The edge servers 104, 106, 108 transmit model updates generated as a result of the training to the cloud server 102. The cloud server 102 aggregates the model updates provided by the edge servers 104, 106, 108. In the example of FIG. 1, the cloud server 102 serves as an aggregator device that aggregates training results from the edge server(s) 104, 106, 108. Thus, the example system 100 of FIG. 1 provides a federated or distributed learning environment in which training of the model 116 is performed using local data associated with the respective edge devices 110, 112, 114 and the corresponding training results are aggregated by the cloud server 102.

In the example of FIG. 1, each of the edge servers 104, 106, 108 includes a federated learning (FL) accelerator 118 (e.g., a first FL accelerator). In some examples, the edge servers 104, 106, 108 include two or more FL accelerators 118. The FL accelerator 118 represents hardware and/or software used to execute a workload in connection with the training of the model 116. In particular, the FL accelerator 118 is used to accelerate workloads or operations associated with federated learning. As disclosed herein, in some examples, the edge servers 104, 106, 108 can include other accelerators, such as an artificial intelligence (AI) accelerator, to accelerate (other) operations or workloads in connection with training of the model 116.

For example, the FL accelerator 118 of the first edge server 104 can accelerate distributed operations such as operations for data encryption or data embedding performed by the first edge server 104. The FL accelerator 118 of the first edge server 104 can accelerate other FL operations such as filtering of data prior to model training, broadcasting the model updates generated as a result of training on the first edge server 104 to the cloud server 102, etc. In some examples, the operations performed by the FL accelerator(s) 118 are customized based on properties of the particular edge server 104, 106, 108 at which the FL accelerator 118 is to be implemented (e.g., processing resources) and/or based properties of the data provided by the corresponding edge devices 110, 112, 114 (e.g., raw data, filtered data).

The example FL accelerator(s) 118 of FIG. 1 can include FPGA-based accelerator(s). In some examples, the FL accelerator(s) 118 are CPU-based accelerator(s). In other examples, the FL accelerator(s) 118 are combined CPU and FPGA based accelerator(s). In some examples, the FL accelerator(s) 118 are specialized hardware. The example FL accelerator(s) 118 can be implemented by any other past, present, and/or future accelerator such as, for example, a digital signal processor (DSP-based architecture).

In the example of FIG. 1, the cloud server 102 includes a FL accelerator 120 (e.g., a second FL accelerator). The FL accelerator 120 associated with the cloud server 102 accelerates federated learning operations performed at the cloud server 102 to, for instance, aggregate the model updates received from the edge servers 104, 106, 108. The FL accelerator 120 of FIG. 1 can include FPGA-based accelerator(s), CPU-based accelerator(s), combined CPU and FPGA based accelerator(s), specialized hardware and/or software, etc. The example FL accelerator(s) 120 can be implemented by any other past, present, and/or future accelerator.

Although in the example of FIG. 1, the edge servers 104, 106, 108 are shown as each including the FL accelerator 118, in some examples, only some of the edge servers 104, 106, 108 include the FL accelerators. Also, although in the example system 100 of FIG. 1 the edge server(s) 104, 106, 108 include the FL accelerator(s) 118 and the cloud server 102 includes the FL accelerator 120, in other examples, only edge server(s) 104, 106, 108 include the FL accelerator(s) 118; alternatively, in some examples, only the cloud server 102 includes the FL accelerator 120.

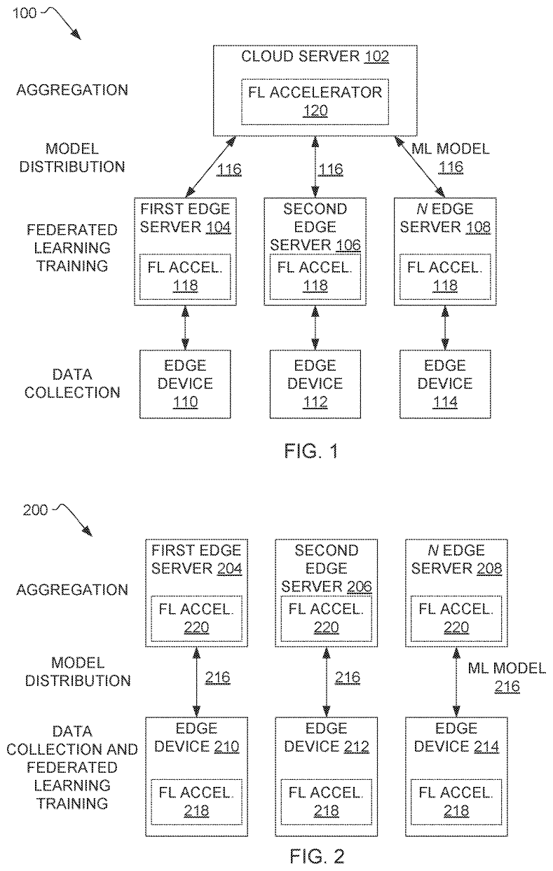

FIG. 2 is a block diagram of a second example system 200 constructed in accordance with teachings of this disclosure to provide training of a neural network using federated learning. The example system 200 includes a first edge server 204, a second edge server 206, and n^{th} edge server 208.

In the example of FIG. 2, the first edge server 204 is in communication with a first edge device 210, the second edge server 206 is in communication with a second edge device 212, and the n^{th} edge server 208 is in communication with an n^{th} edge device 214. The edge devices 210, 212, 214 of FIG. 2 can be implemented by a computing platform such as an Internet of Things (IoT) device (e.g., an IoT sensor), a smartphone, a personal computer, etc. as disclosed in connection with the example edges devices 110, 112, 114 of FIG. 1. The edge devices 210, 212, 214 can include one or more individual edge devices, respectively. For instance, the first edge device 210 can be implemented as an IoT device, which includes thousands of devices, millions of devices, etc. The edges devices 210, 212, 214 of FIG. 2 collect data (e.g., sensor data).

In the example system 200 of FIG. 2, the edge servers 204, 206, 208 distribute a machine learning (ML) model 216 to the corresponding edge devices 210, 212, 214 for training of the ML model 216 at the edge devices 210, 212, 214. For example, the first edge server 204 distributes the ML model 216 to the first edge device 210. The first edge device 210 trains the ML model 216 using the data collected by the first edge device 210 (e.g., where the first edge device 210 can include, for instance, hundreds, thousands, millions, etc. of edge devices that train the model) . The first edge device 210 transmits model update(s) as a result of training to the first edge sever 204 (e.g., where the first edge device 210 can include, for instance, hundreds, thousands, millions, etc. of edge devices that provide model update(s)). Similarly, the second edge server 206 distributes the ML model 216 to the second edge device 212. The second edge device 212 trains the ML model 216 using the data collected by the second edges device 212. The second edge device 212 transmit model update(s) as a result of training to the second edge sever 206. Similarly, the n^{th} edge device 214 trains the ML model 216 using local data and transmits model update(s) to the n^{th} edge server 208. In the example of FIG. 2, each of the edge servers 204, 206, 208 serves as an aggregator device to aggregate training results from the corresponding edge devices 210, 212, 214. For instance, the first edge server 204 can aggregate model updates generated by two or more edge devices that define the first edge device 210. Thus, as compared to the example system 100 of FIG. 1 in which machine learning training occurs at the edge server(s) 104, 106, 108 and aggregation occurs in the cloud 102, in the example of FIG. 2, the training occurs at the edge devices 210, 212, 214 (e.g., IoT devices) and aggregation of the model updates occurs at the edge server(s) 204, 206, 208.

In the example of FIG. 2, federated learning accelerators (e.g., hardware and/or software) can be used to accelerate operation(s) performed by the respective edge servers 204, 206, 208 and/or the respective edge devices 210, 212, 214. For example, the first edge device 210 can include a (e.g., first) FL accelerator 218 to accelerate federated learning operation(s) or workload(s) performed by the first edge device 210 in connection with the training of the ML model 216. The FL accelerator 218 can accelerate operations including, but not limited to, for instance, data preprocessing and/or encryption of the local data used for training. Any of the second edge device 212 and/or the n^{th} edge device 214 can additionally or alternatively include an FL accelerator 218. In the example of FIG. 2, one or more of the edge servers 204, 206, 208 can include a (e.g., second) FL accelerator 220 (e.g., hardware and/or software) to accelerate federated learning operation(s) performed by the edge servers 204, 206, 208 with respect to, for example, aggregation of model update(s) received from the corresponding edge devices 210, 212, 214.

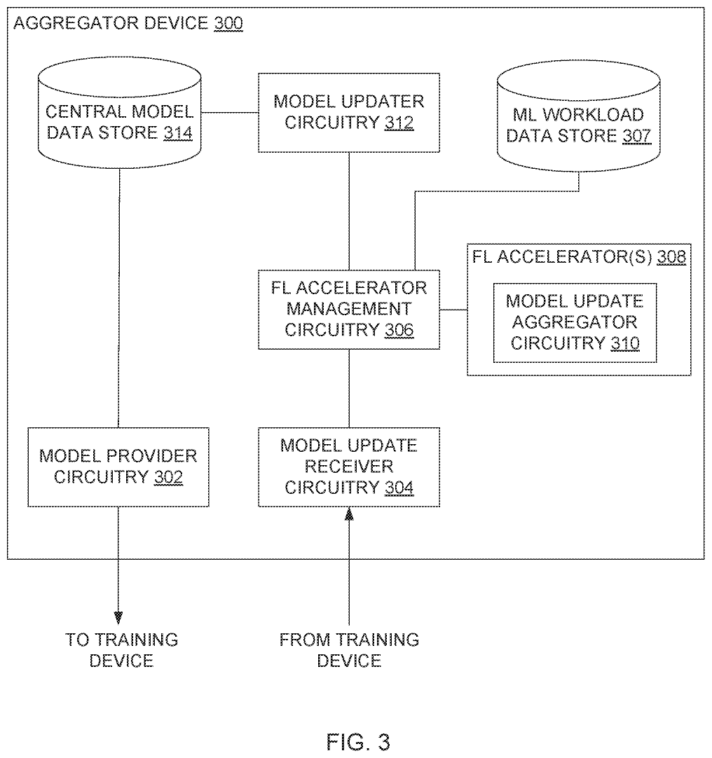

FIG. 3 is a block diagram of an example implementation of an aggregator device 300. In some examples, the example aggregator device 300 of FIG. 3 is implemented by a cloud server such as the cloud server 102 of the example system 100 of FIG. 1. In other examples, the aggregator device 300 is implemented by an edge server such as the edge server(s) 204, 206, 208 of the example system 200 of FIG. 2. In the example of FIG. 3, the aggregator device 300 is in communication with training devices. In examples in which the aggregator device 300 is implemented by the cloud server 102 of FIG. 1, the training devices can include the edge servers 104, 106, 108 of the example system 100 of FIG. 1. In examples in which the aggregator device 300 is implemented by the edge server(s) 204, 206, 208 of FIG. 2, the training devices can include the corresponding edge devices 210, 212, 214 of the example system 200 of FIG. 2.

The example aggregator device 300 of FIG. 3 includes model provider circuitry 302, model update receiver circuitry 304, federated learning (FL) accelerator management circuitry 306, a machine learning (ML) workload data store 307, one or more FL accelerators 308 (e.g., the FL accelerator 120 of the cloud server 102 of FIG. 1, the FL accelerator(s) 220 of the edge server(s) 204, 206, 208 of FIG. 2), model update aggregator circuitry 310, model update circuitry 312, and a central model data store 314.

The example model provider circuitry 302 of FIG. 3 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. The example model provider circuitry 302 provides a machine learning model (e.g., the ML model 116 of FIG. 1, the ML model 216 of FIG. 2) to each training device in communication with the aggregator device 300. Thus, the model provider circuitry 302 implements means for providing a machine learning model (model providing means). In particular, the model provider circuitry 302 provides a current state of the ML model (e.g., based on any previous training results received from the training device(s)) to each training device. In some examples, the model provider circuitry 302 provides instructions regarding the ML model, such as, for examples, threshold values to be used by the training device when training the ML model.

The example model update receiver circuitry 304 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. The example model update receiver circuitry 304 receives model updates from the training device(s) (e.g., the edge servers 104, 106, 108 in the example of FIG. 1; the edge devices 210, 212, 214 of FIG. 2). Thus, the model update receiver circuitry 304 implements means for receiving model updates (model update receiving means).

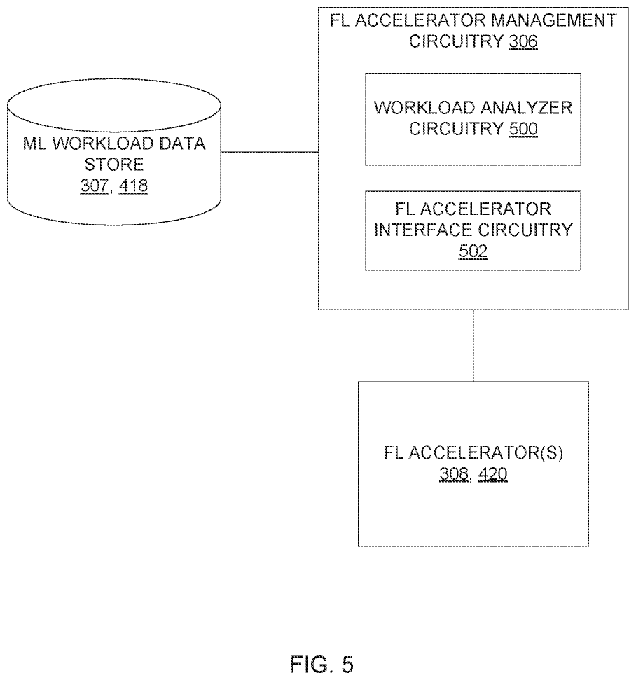

The FL accelerator management circuitry 306 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. The example FL accelerator management circuitry 306 instructs the FL accelerator(s) 308 to perform one or more FL operation(s) or workload(s) in connection with, for instance, aggregation of the model update(s) received by the model update receiver circuitry 304. Thus, the FL accelerator management circuitry 306 implements means for managing an accelerator (accelerator managing means). An example implementation of the FL accelerator management circuitry 306 is disclosed in connection with FIG. 5.

In the example of FIG. 3, the FL accelerator manager circuitry 306 generates the instructions for the FL accelerator(s) 308 based on rule(s) defined in the ML workload data store 307. The example ML workload data store 307 of FIG. 3 is implemented by any memory, storage device and/or storage disc for storing data such as, for example, flash memory, magnetic media, optical media, etc. Furthermore, the data stored in the example ML workload data store 307 may be in any data format such as, for example, binary data, comma delimited data, tab delimited data, structured query language (SQL) structures, etc. Although in the illustrated example of FIG. 3 the ML workload data store 307 is illustrated as a single element, the example ML workload data store 307 and/or any other data storage elements described herein may be implemented by any number and/or type(s) of memories.

The FL accelerator(s) 308 of FIG. 3 can include, for example, FPGA-based accelerator(s). In some examples, the FL accelerator(s) 308 include CPU-based accelerator(s). In some examples, the FL accelerator(s) 308 include combined CPU and FPGA accelerator(s). In some examples, the FL accelerator(s) 308 include FPGA-based accelerator(s) and CPU-based accelerator(s) used in combination. Additionally or alternatively, the FL accelerator(s) 308 can be specialized hardware. The FL accelerator(s) 308 can include any other past, present, and/or future type of accelerator. For example, the FL accelerator(s) 308 can be implemented by a graphics processing unit-based (GPU-based) or a digital signal processor-based (DSP-based) architecture. The FL accelerator(s) 308 implement means for accelerating federated learning workloads or operations (accelerating means).

In the example of FIG. 3, the FL accelerator(s) 308 include the model update aggregator circuitry 310. The model update aggregator circuitry 310 aggregates the model update(s) provided by the training devices. Thus, the model update aggregator circuitry 310 implements means for aggregating model updates (model update aggregator means). In some examples, the model update aggregator circuitry 310 aggregates the model updates as the model updates are received by the model update receiver circuitry 304. In other examples, the model update aggregator circuitry 310 applies one or more rules that define parameters for aggregation of the model updates to, for instance, prevent one of the training devices from having undue influence on the ML model. Thus, in the example of FIG. 3, aggregation of the model update(s) is performed by the FL accelerator(s) 308, thereby offloading the aggregation workload(s) from general computing resource(s) (e.g., a CPU) associated with the aggregator device 300. The FL accelerator(s) 308 of FIG. 3 can include other circuitry to perform federated learning operations at the aggregator device 300.

The example model updater circuitry 312 of FIG. 3 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. The example model updater circuitry 312 updates the ML model (e.g., the ML model 116 of FIG. 1, the ML model 216 of FIG. 2) stored in the central model data store 314 based on the model update(s) received from the training devices and aggregated by the model update aggregator circuitry 310. Thus, the model updater circuitry 312 implements means for updating a machine learning model (model updating means).

The example central model data store 314 of FIG. 3 is implemented by any memory, storage device and/or storage disc for storing data such as, for example, flash memory, magnetic media, optical media, etc. Furthermore, the data stored in the example central model data store 314 may be in any data format such as, for example, binary data, comma delimited data, tab delimited data, structured query language (SQL) structures, etc. Although in the illustrated example of FIG. 3 the central model data store 314 is illustrated as a single element, the example central model data store 314 and/or any other data storage elements described herein may be implemented by any number and/or type(s) of memories. In the illustrated example of FIG. 3, the central model data store 314 stores a central ML model that is updated by the model updater circuitry 312 based on the model updates received from the training devices. The central ML model stored by the central model data store 314 (e.g., a current state of the ML model including the model updates) is transmitted to the training devices by the model provider circuitry 302 in connection with, for example, another training round at the training devices.

Although in the example of FIG. 3, the FL accelerator(s) 308 are shown as including the model aggregator circuitry 310, the FL accelerator(s) 308 can perform other FL operation(s) or workload(s) in connection with the model update(s) received from the training devices. For instance, in some examples, the FL accelerator(s) 308 can include the model update circuitry 312 that updates the ML model stored in the central model data store. Thus, the FL accelerator(s) 308 can offload one or more workloads associated with the model update(s) received from the training devices.

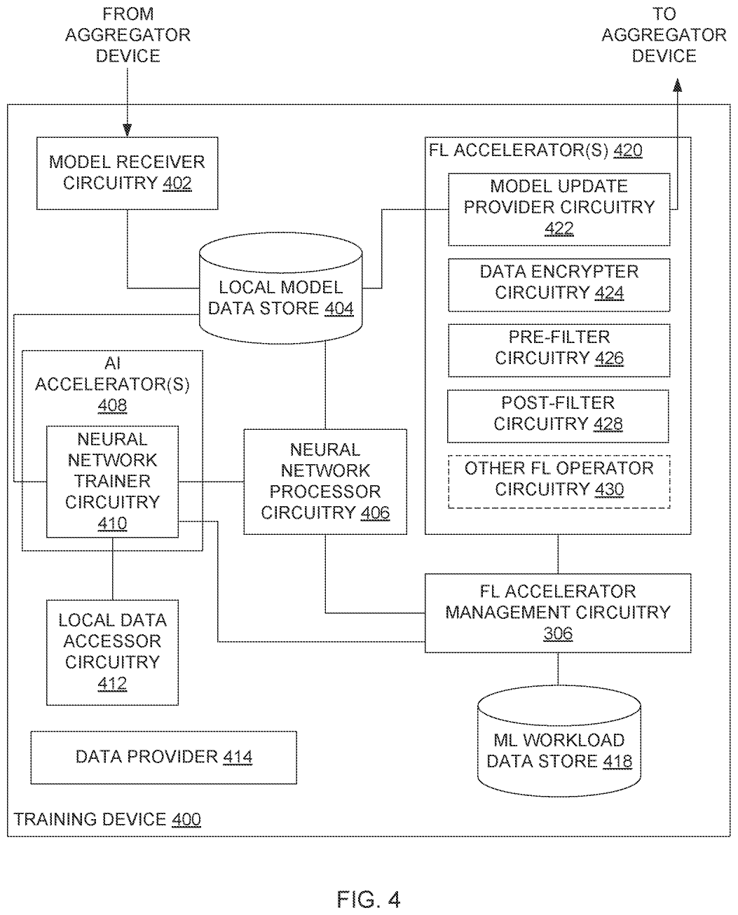

FIG. 4 is a block diagram of an example implementation of a training device 400. In some examples, the example training device 400 of FIG. 4 is implemented by an edge server such as the edge servers 104, 106, 108 of FIG. 1. In other examples, the training device 400 is implemented by an edge device such as the example edge devices 210, 212, 214 of FIG. 2.

The example training device 400 of FIG. 4 includes model receiver circuitry 402, a local model data store 404, neural network processor circuitry 406, one or more artificial intelligence (AI) accelerators 408, neural network trainer circuitry 410, local data accessor circuitry 412, a data provider 414, the FL accelerator management circuitry 306, a ML workload data store 418, and one or more FL accelerators 420 (e.g., the FL accelerator(s) 118 of the edge servers(s) 104, 106, 108 of FIG. 1; the FL accelerator(s) 218 of the edge device(s) 210, 212, 214 of FIG. 2). In the example of FIG. 4, the FL accelerators 420 include model update provider circuitry 422, data encrypter circuitry 424, pre-filter circuitry 426, post-filter circuitry 428, and/or other types of FL operator circuitry 430.

The model receiver circuitry 402 of the example training device of FIG. 4 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. The example model receiver circuitry 402 receives the current state of the ML model (e.g., the central model stored in the central model data store 314 of the aggregator device 300 of FIG. 3, such as the ML model 116 of FIG. 1 or the ML model 216 of FIG. 2). Thus, the model receiver circuitry 402 implements means for receiving a model (model receiving means). In some examples, the model receiver circuitry 402 receives instructions regarding the model and/or training thereof from the aggregator device 300 of FIG. 3 (e.g., from the model provider circuitry 302 of the aggregator device 300) such as threshold values to be used by the training device 400 when training the model. In the example of FIG. 4, the model receiver circuitry 402 stores the ML model received from the aggregator device 300 in the local model data store 404.

The example local model data store 404 of FIG. 4 is implemented by any memory, storage device and/or storage disc for storing data such as, for example, flash memory, magnetic media, optical media, etc. Furthermore, the data stored in the local model data store 404 may be in any data format such as, for example, binary data, comma delimited data, tab delimited data, structured query language (SQL) structures, etc. While in the illustrated example the local model data store 404 is illustrated as a single element, the example local model data store 404 and/or any other data storage elements described herein may be implemented by any number and/or type(s) of memories. In the example of FIG. 4, the local model data store 404 stores local model information received from the model receiver circuitry 402 and/or updated (e.g., trained) by the neural network trainer circuitry 410.

The example neural network processor circuitry 406 of FIG. 4 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example neural network processor circuitry 406 implements a neural network. Thus, the model receiver circuitry 402 implements means for implementing a neural network (neural network implementing means). For example, the neural network processor circuitry 406 can implement a deep neural network (DNN). However, any other past, present, and/or future neural network topology(ies) and/or architecture(s) may additionally or alternatively be used such as, for example, a convolutional neural network (CNN) or a feed-forward neural network.

In the example of FIG. 4, the training device includes the AI accelerator(s) 408 to accelerate training of the neural network. Thus, the AI accelerator(s) 408 implement means for accelerating training (training accelerating means). In this example, the AI accelerator(s) 408 includes the neural network trainer circuitry 410. The AI accelerator(s) 408 can include FPGA-based accelerator(s), CPU-based accelerator(s), and/or combinations thereof. The AI accelerator(s) 408 can include any other past, present, and/or future type of accelerator. In other examples, the training device 400 does not include the AI accelerator(s) 408. In such examples, the neural network trainer circuitry 410 can be implemented by a logic circuit such as, for example, a hardware processor and/or other circuitry such as, for example, one or more analog or digital circuit(s), logic circuits, programmable processor(s), ASIC(s), PLD(s), FPLD(s), DSP(s), etc.

The example neural network trainer circuitry 410 performs training of the neural network implemented by the neural network processor circuitry 406. Thus, the neural network trainer circuitry 410 implements means for training a neural network (neural network training means). For instance, the neural network trainer circuitry 410 can train the neural network using Stochastic Gradient Descent. However, any other approach to training a neural network may additionally or alternatively be used. Thus, in the example of FIG. 4, the training of the neural network is performed by the specialized AI accelerator(s) 408, thereby offloading the training from the general computing resource(s) of the training device. However, in other examples, the training device 400 does not include the AI accelerator(s) 408. In such examples, the neural network trainer circuitry 410 can be implemented by, for instance, a central processing unit (CPU) of the training device 400.

The example local data accessor circuitry 412 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example local data accessor circuitry 412 accesses local data to be used for training from the data provider 414. Thus, the local data accessor circuitry 412 implements means for accessing local data (local data accessing means). The example data provider 414 can include, for instance, a program, a device, etc. that collects data, where the data is used as training data by the training device 400.

The example FL accelerator management circuitry 306 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. The example FL accelerator management circuitry 306 instructs the FL accelerator(s) 420 to perform one or more FL operation(s) or workload(s) in connection with distributed training of the ML model at the training device 400.

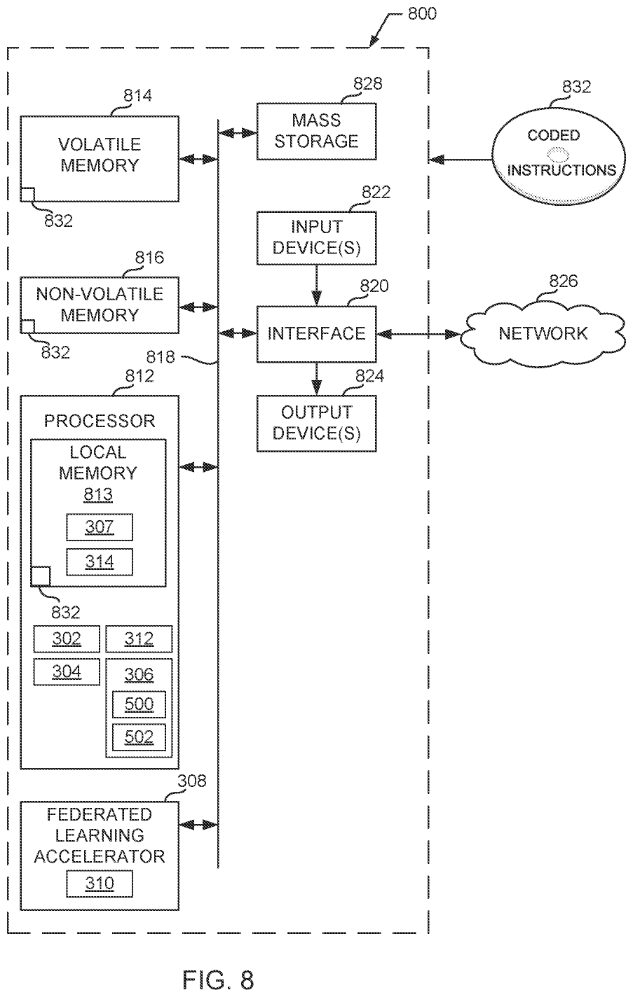

In the example of FIG. 4, the FL accelerator management circuitry 306 generates the instructions for the FL accelerator(s) 420 based on rule(s) defined in the ML workload data store 418. The example ML workload data store 418 of FIG. 8 is implemented by any memory, storage device and/or storage disc for storing data such as, for example, flash memory, magnetic media, optical media, etc. Furthermore, the data stored in the example ML workload data store 418 may be in any data format such as, for example, binary data, comma delimited data, tab delimited data, structured query language (SQL) structures, etc. Although in the illustrated example of FIG. 4 the ML workload data store 418 is illustrated as a single element, the example ML workload data store 418 and/or any other data storage elements described herein may be implemented by any number and/or type(s) of memories.

The example training device 400 of FIG. 4 includes the FL accelerator(s) 420. The FL accelerator(s) 420 of FIG. 4 can include FPGA-based accelerator(s), CPU-based accelerator(s), and/or combinations thereof. In some examples, the FL accelerator(s) 416 are specialized hardware. The FL accelerator(s) 420 can include any other past, present, and/or future type of accelerator (e.g., combined FPGA-CPU accelerators, DSP-based accelerators, etc.). The FL accelerator(s) 420 implement means for accelerating federated learning workloads or operations (accelerating means).

In the example of FIG. 4, the FL accelerator(s) 420 facilitate performance of one or more FL operations in connection with the distributed training of the model by the training device 400. For example, the FL accelerator(s) 420 include model update provider circuitry 422. The model update provider circuitry 422 provides model update(s) generated as a result of the training of the neural network to the aggregator device 300 of FIG. 3. Thus, the model update provider circuitry 422 implements means for providing model updates (model update providing means). In some examples, the model update provider circuitry 422 provides additional information with the model update(s) such as an identity of the training device 400 (e.g., the particular one of the edge server 104, 106, 108 of FIG. 1 that performed the training, or the particular one of the edge device 210, 212, 214 of FIG. 2 that performed the training), an indication of how much training data was used to prepare the model update, and/or other parameters associated with the model training process. Thus, in the example of FIG. 4, the transmission or broadcast of the model update(s) to the aggregator device 300 of FIG. 3 is an FL operation performed by the FL accelerator(s) 420.

The FL accelerator(s) 420 of the example training device 400 of FIG. 4 can provide for offloading of other FL operations or workloads from the general computing resource(s) of the training device 400. For example, the FL accelerator(s) 420 of FIG. 4 include data encrypter circuitry 424. The data encrypter circuitry 424 encrypts or create embeddings of the local data prior to use of the data for training such that only the training device 400 that encrypted or embedded the data can access the original data. Thus, the data encrypter circuitry 424 implements means for protecting data (data protecting means). Encryption or embedding of the local data prevents the data from being shared across an FL environment (e.g., between edge devices).

The example FL accelerator(s) 420 of FIG. 4 include pre-filter circuitry 426, to filter or otherwise pre-process the local data to be used for training (e.g., means for post-filtering data or post filtering means). For example, the pre-filter circuitry 426 can remove noise from the data, identify relevant data for training from large datasets, etc.). The example FL accelerator(s) 420 of FIG. 4 include post-filter circuitry 428 to, for instance, remove noise from the training results (e.g., means for post-filtering data or post filtering means).

The example FL accelerator(s) 420 of FIG. 4 can provide for performance of other FL operations at the training device 400, as represented by the other FL operator circuitry 430 in FIG. 4. For instance, the FL accelerator(s) 420 can perform operations to address data sparsity or missing data in the local data prior to using the data for training, to address differences in data format(s) or data type(s) within the local data associated with the training device 400, and/or to perform distributed statistical summary generation . Such operations can be customized based on the properties of the data associated with each training device 400. Thus, the example FL accelerator(s) 420 can provide for customized processing of the data used for training based on differences data formats, levels or amounts of data sparsity, data types, etc. at an edge device and/or across an edge system.

Thus, in the example of FIG. 4, one or more FL operations is offloaded from being performed by the general computing resource(s) (e.g., a CPU) of the training device 400, thereby lowering resource utilization by the general computing resource(s), enabling other applications to run on the general computing resource(s), etc. Further, the FL operations assigned to the FL accelerator(s) 416 can be customized or tailored for each training device 400 (e.g., the edge server(s) 104, 106, 108; the edge device(s) 210 212, 214) based on, for instance, properties of the local data used for training at each device.

FIG. 5 is a block diagram of an example implementation of the FL accelerator management circuitry 306 of FIGS. 3 and/or 4. As disclosed herein, the FL accelerator management circuitry 306 is structured to control operation of the FL accelerator(s) 308 of the aggregator device 300 of FIG. 3 when implemented at the aggregator device and/or to control operation of the FL accelerator(s) 420 of the training device when implemented at the training device 400 of FIG. 4.

The example FL accelerator management circuitry 306 of FIG. 5 includes workload analyzer circuitry 500. The workload analyzer circuitry 500 implements means for identifying FL operation(s) or workload(s) to be performed by the FL accelerator(s) 308, 420 in connection with the distributed machine learning training and trigger events for initiating the performance of the workload(s). In the example of FIG. 5, the workload analyzer circuitry 500 identifies workloads to be performed by the FL accelerator(s) 308, 420 based on rule(s) stored in the ML workload data store(s) 307, 418. The ML workload data store(s) 307, 418 can includes rules defining operation(s) to be performed by the FL accelerator(s) 308, 420, trigger event(s) for initiating the operation(s) (e.g., receipt of the ML model at the training device 400, completion of the training, etc.), etc. The rules can be defined based on user input(s) with respect to the operation(s) to be performed by the respective FL accelerator(s) 308, 420.

For example, when the FL accelerator management circuitry 306 is executed at the aggregator device 300 of FIG. 3, the workload analyzer circuitry 500 determines that the FL accelerator(s) 308 should be activated in response to the model update receiver circuitry 304 of FIG. 3 receiving model update(s) from the training device(s). In particular, the workload analyzer circuitry 500 determines that the FL accelerator(s) 308 should be activated to enable the model update aggregator circuitry 310 of FIG. 3 to aggregate the model updates received from the training device(s).

As another example, when the FL accelerator management circuitry 306 is executed at the training device 400 of FIG. 4, the workload analyzer circuitry 500 determines that the FL accelerator(s) 420 should be activated in response to receipt of the ML model by the model receiver circuitry 402 of FIG. 4. In particular, the workload analyzer circuitry 500 determines that the FL accelerator(s) 420 should be activated to enable the data encryption circuitry 424 to encrypt or embed the local data to be used for training the model.

As another examples, when the FL accelerator management circuitry 306 is executed at the training device 400 of FIG. 4, the workload analyzer circuitry 500 determines that the FL accelerator(s) 420 should be activated in response to the generation of model updates as a result of the training of the model by the neural network trainer circuitry 410 of FIG. 4.

The example FL accelerator management circuitry 306 of FIG. 5 includes FL accelerator interface circuitry 502. The FL accelerator interface circuitry 502 facilitates communication between the FL accelerator management circuitry 306 and the FL accelerator(s) 308, 420. Thus, the FL accelerator interface circuitry 502 implements means for communicating with the FL accelerator(s) 308, 420 (accelerator communicating means)

For instance, with respect to the example aggregator device 300 of FIG. 3, the FL accelerator interface circuitry 502 transmits instructions to, for instance, the model update aggregator circuitry 310 in response to the workload analyzer circuitry 500 determining that aggregation of the model update(s) should be performed. The instructions can activate the FL accelerator(s) 308.

As another example, in the context of the training device 400 of FIG. 4, the FL accelerator interface circuitry 502 transmits instructions to, for instance, the data encrypter circuitry 424 in response to receipt of the model by the model receiver circuitry 402 to cause the data encrypter circuitry 424 to encrypt or embed the local data for training. The instructions can activate the FL accelerator(s) 420. As another example, the FL accelerator interface circuitry 502 can transmit instructions to the model provider circuitry 422 in response to the generation of model updates by the neural network trainer circuitry 410 to cause the model provider circuitry 422 to transmit the updates via the FL accelerator(s) 420.

While an example manner of implementing the aggregator device 300 is illustrated in FIG. 3, one or more of the elements, processes, and/or devices illustrated in FIG. 3 may be combined, divided, re-arranged, omitted, eliminated, and/or implemented in any other way. Further, the example model provider circuitry 302, the example model update receiver circuitry 304, the example federated learning (FL) accelerator management circuitry 306, the example machine learning (ML) data store 307, the example FL accelerator(s) 308, the example model update aggregator circuitry 310, the example model updater circuitry 312, the example central model data store 314, and/or, more generally, the example aggregator device 300 of FIG. 3 may be implemented by hardware alone or by hardware in combination with software and/or firmware. Thus, for example, any of the example model provider circuitry 302, the example model update receiver circuitry 304, the example FL accelerator management circuitry 306, the example ML data store 307, the example FL accelerator(s) 308, the example model update aggregator circuitry 310, the example model updater circuitry 312, the example central model data store 314, and/or, more generally, the example aggregator device 300 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example aggregator device 300 may include one or more elements, processes, and/or devices in addition to, or instead of, those illustrated in FIG. 3, and/or may include more than one of any or all of the illustrated elements, processes, and devices.

While an example manner of implementing the training device 400 is illustrated in FIG. 4, one or more of the elements, processes, and/or devices illustrated in FIG. 4 may be combined, divided, re-arranged, omitted, eliminated, and/or implemented in any other way. Further, the example federated learning (FL) accelerator management circuitry 306, the example model receiver circuitry 402, the example local model data store 404, the example neural network processor circuitry 406, the example artificial intelligence (AI) accelerator(s) 408, the example neural network trainer circuitry 410, the example local data accessor circuitry 412, the example data provider 414, the example FL accelerator(s) 420, the example machine learning (ML) workload data store 418, the example model update provider circuitry 422, the example data encrypter circuitry 424, the example pre-filter circuitry 426, the example post-filter circuitry 428, the example other FL operator circuitry 430 and/or, more generally, the example training device 400 of FIG. 4 may be implemented by hardware alone or by hardware in combination with software and/or firmware. Thus, for example, any of the example FL accelerator management circuitry 306, the example model receiver circuitry 402, the example local model data store 404, the example neural network processor circuitry 406, the example AI accelerator(s) 408, the example neural network trainer circuitry 410, the example local data accessor circuitry 412, the example data provider 414, the example FL accelerator(s) 420, the example ML workload data store 418, the example model update provider circuitry 422, the example data encrypter circuitry 424, the example pre-filter circuitry 426, the example post-filter circuitry 428, the example other FL operator circuitry 430 and/or, more generally, the example training device 400 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example training device 400 may include one or more elements, processes, and/or devices in addition to, or instead of, those illustrated in FIG. 4, and/or may include more than one of any or all of the illustrated elements, processes, and devices.

While an example manner of implementing the federated learning (FL) accelerator management circuitry 306 of FIGS. 3 and/or 4 is illustrated in FIG. 5, one or more of the elements, processes, and/or devices illustrated in FIG. 5 may be combined, divided, re-arranged, omitted, eliminated, and/or implemented in any other way. Further, the example workload analyzer circuitry 500, the example FL accelerator interface circuitry 502 and/or, more generally, the example FL accelerator management circuitry 306 of FIG. 5 may be implemented by hardware alone or by hardware in combination with software and/or firmware. Thus, for example, any of the example workload analyzer circuitry 500, the example FL accelerator interface circuitry 502 and/or, more generally, the example FL accelerator management circuitry 306 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example FL accelerator management circuitry 306 may include one or more elements, processes, and/or devices in addition to, or instead of, those illustrated in FIG. 5, and/or may include more than one of any or all of the illustrated elements, processes, and devices.

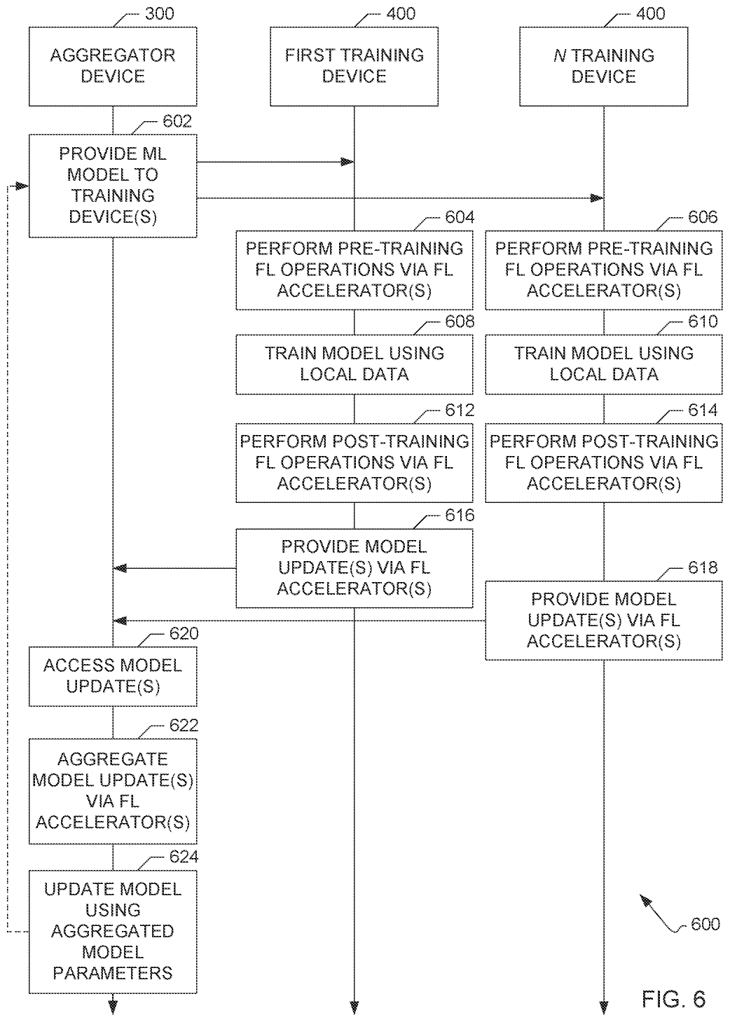

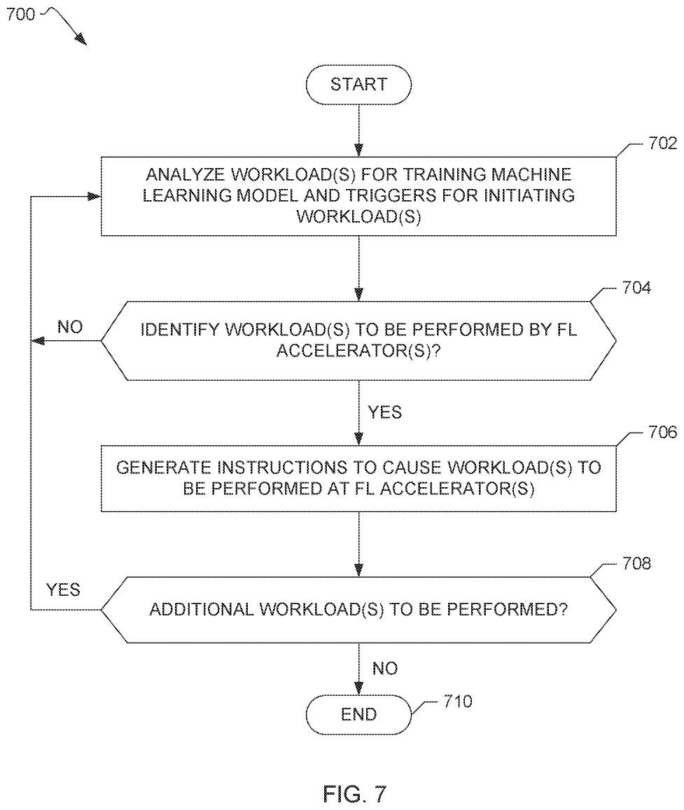

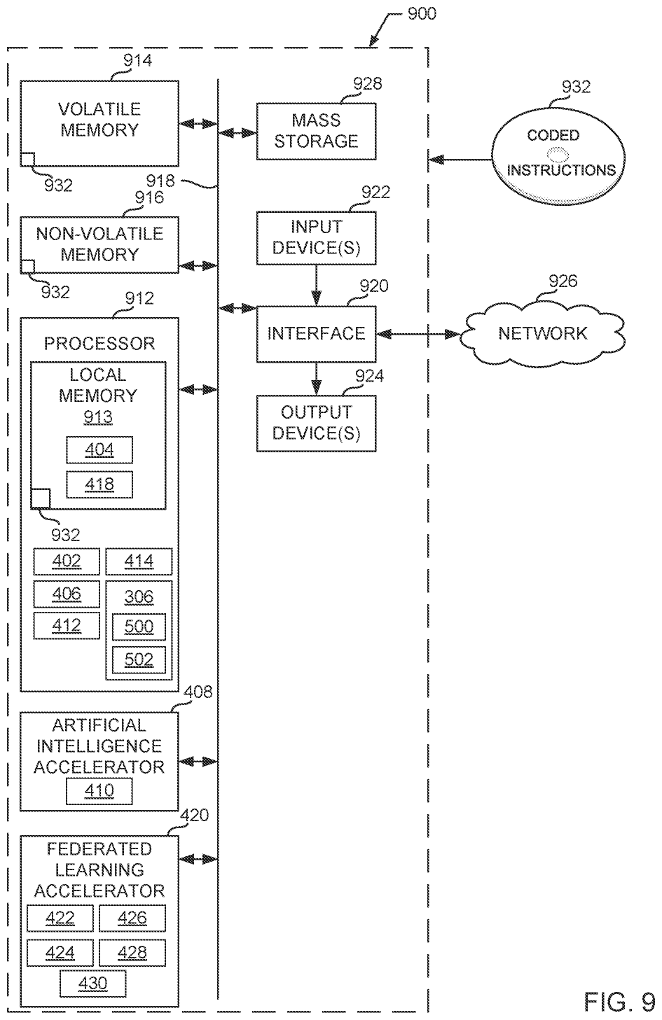

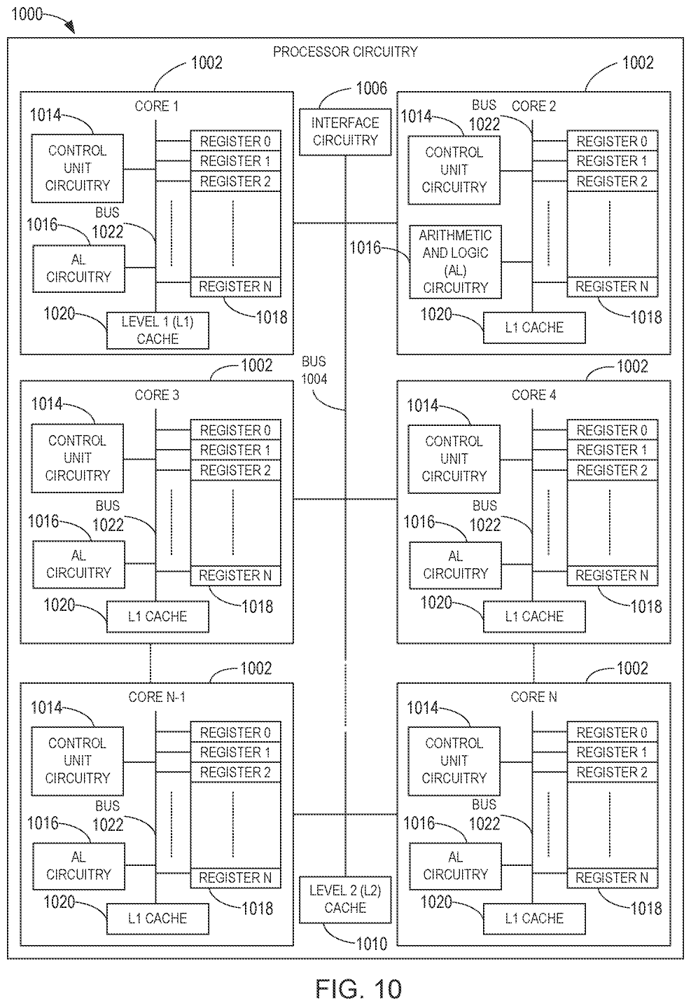

A flowchart representative of example hardware logic circuitry, machine readable instructions, hardware implemented state machines, and/or any combination thereof for implementing the example aggregator device 300 of FIG. 3 and the example training device 400 of FIG. 4 is shown in FIG. 6. A flowchart representative of example hardware logic circuitry, machine readable instructions, hardware implemented state machines, and/or any combination thereof for implementing the example federated learning (FL) accelerator management circuitry 306 of FIGS. 3, 4, and/or 5 is shown in FIG. 7. The machine readable instructions may be one or more executable programs or portion(s) of an executable program for execution by processor circuitry, such as the processor circuitry 812, 912 shown in the example processor platforms 800, 900 discussed below in connection with FIGS. 8 and 9 and/or the example processor circuitry discussed below in connection with FIGS. 10 and/or 11. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6 and/or 7, many other methods of implementing the example aggregator device 300, the example training device 400, and/or the example FL accelerator management circuitry 306 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and/or 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a communication flow diagram representing operations 600 performed at the aggregator device 300 and/or the training devices 400 of FIGS. 3 and 4. As disclosed herein, in some examples, the aggregator device 300 is implemented by the cloud server 102 of FIG. 1 and the training devices 400 are implemented by the respective the edge server(s) 104, 106, 108 of FIG. 1. In other examples, the aggregator device 300 is implemented by the respective edge server(s) 204, 206, 208 and the training devices 400 are implemented by the corresponding edge devices 210, 212, 214 of FIG. 2.

The example process 600 of FIG. 6 begins when the model provider circuitry 302 of the aggregator device 300 provides a current state of the ML model to each training device 400 (block 602).

In the example of FIG. 6, the training devices 400 perform pre-training federated learning (FL) operations via the FL accelerator(s) 420 (e.g., the FL accelerator 118 of the edge server(s) 104, 106, 108 of FIG. 1; the FL accelerator 218 of the edge device(s) 210, 212, 214) associated with each training device 400 (blocks 604, 606). For example, in response to receipt of the ML model by the model receiver circuitry 402 of each training device 400, the FL accelerator management circuitry 306 can generate instructions to cause the data encrypter circuitry 424 to encrypt or embed the local data to be used for training. In some examples, the pre-filter circuitry 426 of one or more of the training devices 400 filters the local data associated with that training device. The pre-training FL operations can include other data preprocessing functions based on, for example, properties of the local data such as data format, data type, data sparsity, etc. (e.g., performed by other FL operator circuitry 430 of the FL accelerator(s) 420).

Each training device 400 trains the ML model using the local data (blocks 608, 610). In examples disclosed herein, the neural network trainer circuitry 410 of the each of the example training devices 400 trains the model implemented by the neural network processor circuitry 406 using the local data accessed by the local data accessor circuitry 412 from the data provider 414. As a result of the training, a model update for that training round is created and is stored in the local model data store 404 associated with each training device 400. In examples disclosed herein, the model update can be computed with any sort of model learning algorithm such that the aggregation function does not require access to the original data such as, for example, Stochastic Gradient Descent. Also, as disclosed herein, in some examples, the neural network trainer circuitry 410 can be implemented by one or more AI accelerators 408.

In the example of FIG. 6, the training devices 400 perform post-training FL operations via the FL accelerator(s) 420 (e.g., the FL accelerator 118 of the edge server(s) 104, 106, 108 of FIG. 1; the FL accelerator 218 of the edge device(s) 210, 212, 214) associated with each training device 400 (blocks 612, 614). For example, the post-filter circuitry 428 of one or more of the training devices 400 can filter the training results associated with the respective device.

Each training device 400 transmits the model update generated at that particular device to the aggregator device 300 (blocks 616, 618). In the example of FIG. 6, the model update provider circuitry 422 is implemented by the FL accelerator 416 of each training device 400 to facilitate broadcasting of the model update(s) to the aggregator device 300.

The model update receiver circuitry 304 of the aggregator device 300 receives the model updates transmitted by the training devices 400 (block 620). The model updates are aggregated by the aggregator device 300 (block 622). In the example of FIG. 6, the aggregation of the model updates is performed via the FL accelerator(s) 308 of the aggregator device 300. For example, the FL accelerator management circuitry 306 of the aggregator device 300 transmits instructions to cause the model update aggregator circuitry 310 to aggregate the model updates.

The model updater circuitry 312 of the aggregator device 300 updates the model stored in the central model data store 314 using the aggregated model parameters (block 624). The updated model serves as the new model for the next training round. Control proceeds to block 602 to initiate the next training round.

FIG. 7 is a flowchart representative of example machine readable instructions and/or example operations 700 that may be executed and/or instantiated by processor circuitry to cause one or more federated learning (FL) operations or workloads to be performed via one or more FL accelerator(s). The example instructions 700 of FIG. 7 can be implemented by the FL accelerator management circuitry 306 of the aggregator device 300 of FIG. 3 to manage the FL accelerator(s) 308 of the aggregator device 300. Additionally or alternatively, the example instructions 700 of FIG. 7 can be implemented by the FL accelerator management circuitry 306 of the training device 400 of FIG. 4 to manage the FL accelerator(s) 420 of the training device 400.

The machine readable instructions and/or operations 700 of FIG. 4 begin at block 702, at which the workload analyzer circuitry 500 analyzes workload(s) to be performed in connection with distributed training of a machine learning model to identify workload(s) that are to be performed by the FL accelerator(s) 308, 420 and trigger event(s) for initiating the workload(s). The workload analyzer circuitry 500 identifies the workloads to be performed by FL accelerator(s) 308, 420 and the corresponding initiation trigger event(s) based on rules stored in the respective ML workload data stores 307, 418. For example, when the FL accelerator management circuitry 306 is executed at the aggregator device 300 of FIG. 3, the workload analyzer circuitry 500 determines that the FL accelerator(s) 308 should be activated in response to the model update receiver circuitry 304 of FIG. 3 receiving model update(s) from the training device(s) 400 to enable aggregation of the model updates by the model update aggregator circuitry 310. As another example, when the FL accelerator management circuitry 306 is executed at the training device 400 of FIG. 4, the workload analyzer circuitry 500 determines that the FL accelerator(s) 420 should be activated in response to the generation of model updates as a result of the training of the model by the neural network trainer circuitry 410 of FIG. 4.

In the example of FIG. 7, when the workload analyzer circuitry 500 identifies workload(s) to be performed by the FL accelerator(s) 308, 420 (block 704), the FL accelerator interface circuitry 502 generates instructs to cause the workload(s) to be performed at the FL accelerators (block 706). In some examples, the instructions from the FL accelerator interface circuitry 502 cause the FL accelerators 308, 420 to be activated. For example, when executed at the aggregator device 300 of FIG. 3, the FL accelerator interface circuitry 502 can transmit instructions for the model update aggregator circuitry 310 in response to the workload analyzer circuitry 500 determining that aggregation of the model update(s) should be performed. As another example, when executed at the training device 400, the FL accelerator interface circuitry 502 transmits instructions to the data encrypter circuitry 424 in response to receipt of the model by the model receiver circuitry 402 to cause the data encrypter circuitry 424 to encrypt or embed the local data for training.

Control continues to analyze the workload(s) in connection with distributed training until there are no further workloads to be performed (blocks 708, 710).

FIG. 8 is a block diagram of an example processor platform 800 structured to execute and/or instantiate the machine readable instructions and/or operations of FIGS. 6 and/or 7 to implement the example aggregator device 300 of FIG. 3. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example model provider circuitry 302, the example model update receiver circuitry 304, the example federated learning accelerator management circuitry 306, the example workload analyzer circuitry 500, the example federated learning accelerator interface circuitry 502, and the example model updater circuitry 312.

The processor platform 800 of the illustrated example includes the federated learning accelerator 308. The federated learning accelerator 308 is implemented by one or more integrated circuits, logic circuits, microprocessors, or controllers from any desired family or manufacturer. In this example, the federated learning accelerator 308 executes the example model update aggregator circuitry 310.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 832, which may be implemented by the machine readable instructions of FIGS. 6 and/or 7, may be stored in the mass storage device 828, in the volatile memory 814, in the non-volatile memory 816, and/or on a removable non-transitory computer readable storage medium such as a CD or DVD.

FIG. 9 is a block diagram of an example processor platform 900 structured to execute and/or instantiate the machine readable instructions and/or operations of FIGS. 6 and/or 7 to implement the example training device 400 of FIG. 4. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example model receiver circuitry 402, the example neural network processor circuitry 406, the example federated learning accelerator management circuitry 306, the example workload analyzer circuitry 500, the example federated learning accelerator interface circuitry 502, and the example local data accessor circuitry 412, and the example data provider 414.

The processor platform 900 of the illustrated example includes the artificial intelligence accelerator 408. The artificial intelligence accelerator 408 is implemented by one or more integrated circuits, logic circuits, microprocessors, or controllers from any desired family or manufacturer. In this example, the artificial intelligence accelerator 408 executes the example neural network trainer circuitry 410.

The processor platform 900 of the illustrated example includes the federated learning accelerator 420. The federated learning accelerator 420 is implemented by one or more integrated circuits, logic circuits, microprocessors, or controllers from any desired family or manufacturer. In this example, the federated learning accelerator 420 executes the example model update provide circuitry 422, the example data encrypter circuitry 424, the example pre-filter circuitry 426, the example post-filter circuitry 428, and the example other federated learning operator circuitry 430.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 832, which may be implemented by the machine readable instructions of FIGS. 6 and/or 7, may be stored in the mass storage device 828, in the volatile memory 814, in the non-volatile memory 816, and/or on a removable non-transitory computer readable storage medium such as a CD or DVD.

FIG. 10 is a block diagram of an example implementation of the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9. In this example, the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9 is implemented by a microprocessor 1000. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIG. 6 and/or 7.

The cores 1002 may communicate by an example bus 1004. In some examples, the bus 1004 may implement a communication bus to effectuate communication associated with one(s) of the cores 1002. For example, the bus 1004 may implement at least one of an Inter-Integrated Circuit (I2C) bus, a Serial Peripheral Interface (SPI) bus, a PCI bus, or a PCIe bus. Additionally or alternatively, the bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 814, 816 of FIG. 8, the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and an example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The bus 1004 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

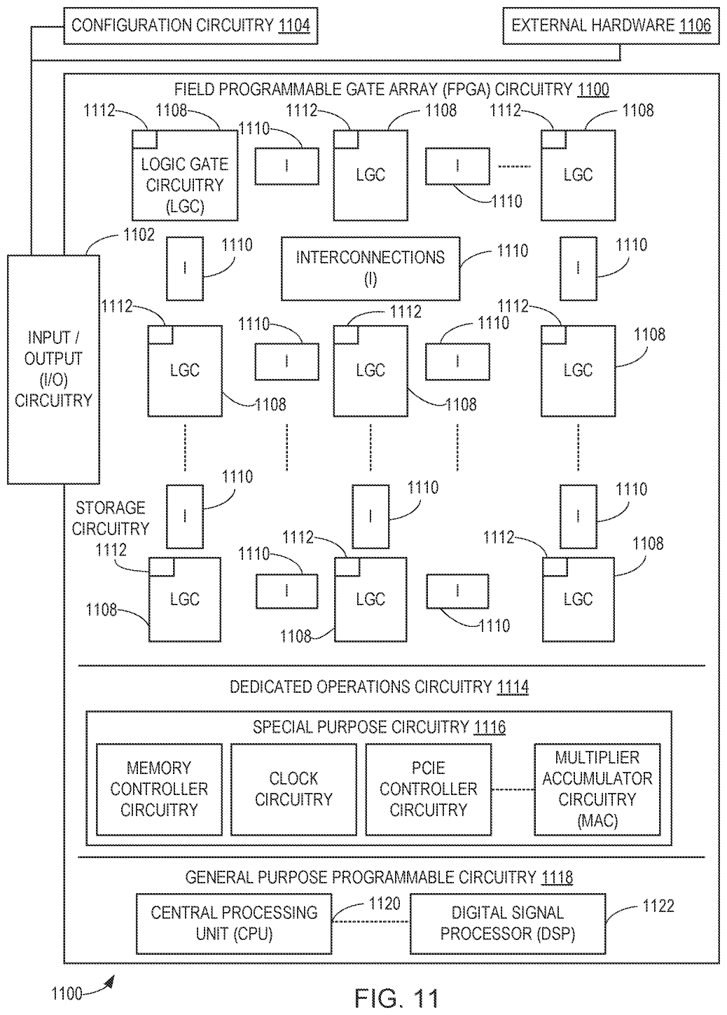

FIG. 11 is a block diagram of another example implementation of the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9. In this example, the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9 is implemented by FPGA circuitry 1100. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 6 and/or 7 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 6 and/or 7. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 6 and/or 7. As such, the FPGA circuitry 1100 may be structured to effectively instantiate some or all of the machine readable instructions of the flowcharts of FIGS. 6 and/or 7 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 6 ad/or 7 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine readable instructions of FIGS. 6 and/or 7 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9, many other approaches are contemplated. For example, as mentioned above, modern FPGA circuitry may include an on-board CPU, such as one or more of the example CPU 1120 of FIG. 11. Therefore, the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 6 and/7 may be executed by one or more of the cores 1002 of FIG. 10 and a second portion of the machine readable instructions represented by the flowcharts of FIG. 6 and/or 7 may be executed by the FPGA circuitry 1100 of FIG. 11.

In some examples, the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9 may be in one or more packages. For example, the processor circuitry 1000 of FIG. 10 and/or the FPGA circuitry 1100 of FIG. 11 may be in one or more packages. In some examples, an XPU may be implemented by the processor circuitry 812 of FIG. 8, the federated learning accelerator 308 of FIG. 8, the processor circuitry 912 of FIG. 9, the artificial intelligence accelerator 408 of FIG. 9, and/or the federated learning accelerator 420 of FIG. 9, which may be in one or more packages. For example, the XPU may include a CPU in one package, a DSP in another package, a GPU in yet another package, and an FPGA in still yet another package.

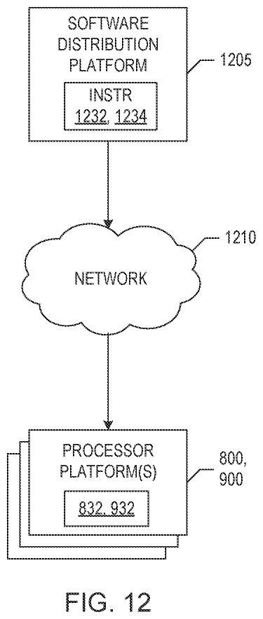

A block diagram illustrating an example software distribution platform 1205 to distribute software such as the example machine readable instructions 832 of FIG. 8 and/or the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 832 of FIG. 8 and/or the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 1232, which may correspond to the example machine readable instructions 832 of FIG. 8, as described above. The storage devices store the machine readable instructions 1234, which may correspond to the example machine readable instructions 932 of FIG. 9, as described above. The one or more servers of the example software distribution platform 1205 are in communication with a network 1210, which may correspond to any one or more of the Internet and/or any of the example networks 826, 926 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232, 1234 from the software distribution platform 1205. For example, the software, which may correspond to the example machine readable instructions 832 of FIG. 8, may be downloaded to the example processor platform 800, which is to execute the machine readable instructions 832 to implement the example aggregator device 300 of FIG. 3. The software, which may correspond to the example machine readable instructions 932 of FIG. 9, may be downloaded to the example processor platform 900, which is to execute the machine readable instructions 932 to implement the example training device 400 of FIG. 4. In some examples, one or more servers of the software distribution platform 1205 periodically offer, transmit, and/or force updates to the software (e.g., the example machine readable instructions 832 of FIG. 8, the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that provide accelerators for performing federated learning (FL) operations in connection with distributed training of a machine learning model. Examples disclosed herein address heterogeneity with respect to availability of computing resources for training within an edge system by enabling federated learning operations or workloads to be executed by the FL accelerator(s), rather than consuming general computing resources. Examples disclosed herein can also address heterogeneity with respect to the local data used for training at each training device by providing for FL accelerator(s) at each device to facilitate data-based operations such as encryption. Example FL accelerators can be implemented as external hardware, as CPU-based accelerators, and/or combinations thereof. Thus, examples disclosed herein provide flexibility in the locations of the FL accelerators based on variables such as a cost, power, etc. The disclosed systems, methods, apparatus, and articles of manufacture improve the efficiency of using a computing device by offloading one or more federated learning operations to an accelerator, thereby increasing speeds at which repeated patterns of computation for machine learning training are performed and, as a result, providing for improved efficiency with respect to performance and power consumption. Further, the use of FL accelerators preserves and/or increases availability of general computing resources that would otherwise perform the training and which could affect device performance. The disclosed systems, methods, apparatus, and articles of manufacture are accordingly directed to one or more improvement(s) in the operation of a machine such as a computer or other electronic device.

Example federated learning accelerators and related methods are disclosed herein. Further examples and combinations thereof include the following:

Example 1 includes Example 1 includes an edge device including neural network trainer circuitry to train a neural network to generate a model update for a machine learning model using local data; a federated learning accelerator to perform one or more federated learning workloads associated with the training; and model update provider circuitry to transmit the model update to an aggregator device.

Example 2 includes the edge device of example 1, wherein the federated learning accelerator includes the model update provider circuitry.

Example 3 includes the edge device of examples 1 or 2, wherein the federated learning accelerator includes data encrypter circuitry to encrypt the local data.

Example 4 includes the edge device of any of examples 1-3, further including federated learning accelerator management circuitry to generate instructions to cause the federated learning accelerator to perform the one or more federated learning workloads.

Example 5 includes the edge device of any of examples 1-4, wherein the federated learning accelerator management circuitry includes federated learning accelerator interface circuitry.

Example 6 includes the edge device of any of examples 1-5, wherein the federated learning accelerator management circuitry includes workload analyzer circuitry to identify a workload to be performed by the federated learning accelerator.

Example 7 includes the edge device of any of examples 1-6, further including model receiver circuitry to receive the machine learning model from the aggregator device.

Example 8 includes the edge device of any of examples 1-7, wherein the federated learning accelerator learning accelerator is to perform one or more data processing operations based on at least one of a data format associated with the local data, a data type associated with local data, or a data sparsity level associated with the local data.

Example 9 includes at least one non-transitory computer readable storage medium including instructions that, when executed, cause processor circuitry of a training device in an edge system to at least cause a federated learning accelerator to perform a workload associated with generating a model update; train a neural network to generate the model update using local data associated with the training device; and cause the model update to be transmitted to an aggregator device in the edge system.

Example 10 includes the at least one non-transitory computer readable storage medium of example 9, wherein the instructions, when executed, are to cause the federated learning accelerator to one or more of encrypt or filter the local data.

Example 11 includes the at least one non-transitory computer readable storage medium of examples 9 or 10, wherein the instructions, when executed, cause the processor circuitry to identify the workload as a workload to be performed by the federated learning accelerator based on a trigger event for initiating the workload.

Example 12 includes the at least one non-transitory computer readable storage medium of any of examples 9-11, wherein the trigger event includes receipt of a machine learning model by the training device.

Example 13 includes the at least one non-transitory computer readable storage medium of any of examples 9-12, wherein the trigger event includes generation of the model update.

Example 14 includes the at least one non-transitory computer readable storage medium of any of examples 9-14, wherein the instructions, when executed, cause the processor circuitry to cause the federated learning accelerator to transmit the model update.

Example 15 includes an apparatus including at least one memory; instructions in the apparatus; and processor circuitry to execute the instructions to train a neural network to generate a model update for a machine learning model using local data associated with a training device in an edge system; perform one or more federated learning workloads associated with the training; and transmit the model update to an aggregator device in the edge system.

Example 16 includes the apparatus of example 15, wherein the processor circuitry is to perform a first federated learning workload to encrypt the local data.

Example 17 includes the apparatus of examples 16 or 17, wherein the processor circuitry is to perform a second federated learning workload to filter the local data.

Example 18 includes the apparatus of any of examples 15-17, wherein the processor circuitry is to identify a workload to be performed as the one or more federated learning workloads based on a trigger event for initiating the workload.

Example 19 includes the apparatus of any of examples 15-18, wherein the trigger event includes receipt of the machine learning model by the training device.

Example 20 includes the apparatus of any of examples 15-19, wherein the trigger event includes generation of the model update.

Example 21 includes the apparatus of any of examples 15-20, wherein the one or more federated learning workloads includes the transmission of the model update.

Example 22 includes a system for federated training of a neural network, the system including a first edge device; and a second edge device, each of the first edge device and the second edge device to implement respective neural networks to train the machine learning model, the first edge device to provide a first model update to an aggregator device and the second edge device to provide a second model update to the aggregator device, the first edge device including a first federated learning accelerator to perform a first federated learning operation associated with the training of the machine learning model at the first edge device, and the second edge device including a second federated learning accelerator to perform a second federated learning operation associated with the training of the machine learning model at the second edge device.

Example 23 includes the system of example 22, wherein the first federated learning accelerator is to encrypt data associated with the first edge device for the training of the machine learning model at the first edge device and the second federated learning accelerator is to encrypt data associated with the second edge device for the training of the machine learning model at the second edge device.

Example 24 includes the system of examples 22 or 23, wherein the first federated learning accelerator is to encrypt the data in response to receipt of the machine learning model from the aggregator device.

Example 25 includes the system of any of examples 22-24, wherein the first federated learning accelerator is to transmit the model update from the first edge device to the aggregator device and the second federated learning accelerator is to transmit the model update from the second edge device to the aggregator device.

Example 26 includes the system of any of examples 22-25, wherein the federated learning accelerator is implemented separate from a central processing unit of respective ones of the first edge device and the second edge device.

Example 27 includes the system of any of examples 22-26, wherein the first federated learning accelerator is to perform one or more data processing operations for first data associated with the first edge device based on at least one of a data format associated with the first data, a data type associated with first data, or a data sparsity level associated with the first data, the first data to be used for the training of the machine learning model at the first edge device, and the second federated learning accelerator is to perform the one or more data preprocessing operations for second data associated with the second edge device based on at least one of a data format associated with the second data, a data type associated with second data, or a data sparsity level associated with the second data, the second data to be used for the training of the machine learning model at the second edge device, the second data associated with one or more of a different data format, a different data type, or a different data sparsity level than the first data.

Example 28 includes an edge device for federated training of a neural network, the edge device including means for training the neural network using local data to generate a model update; means for accelerating at least one workload associated with the training of the neural network; and means for providing the model update to an aggregator device.

Example 29 includes the edge device of example 28, wherein the accelerating means is to encrypt the local data.

Example 30 includes the edge device of examples 28 or 29, further including means for managing the accelerating means, the means for managing the accelerating means to cause the accelerating means to perform the workload.

Example 31 includes the edge device of any of examples 28-30, wherein the accelerating means includes the model update providing means.

Example 32 includes an aggregator device for federated training of a neural network, the aggregator device including means for updating a machine learning model based on model updates received from a plurality of training devices; and means for accelerating a workload associated with aggregation of the model updates.

Example 33 includes the aggregator device of example 32, wherein the accelerating means includes means for aggregating the model updates to generate aggregated model parameters.

Example 34 includes the aggregator device of examples 32 or 33, further including means for managing the accelerating means, the means for managing the accelerating means to cause the accelerating means to perform the workload.

Example 35 includes the aggregator device of any of examples 32-34, further including means for providing the machine learning model to the plurality of training devices.

Example 36 includes the aggregator device of any of examples 32-35, further including means for receiving the model updates from the plurality of training devices.

Example 37 includes an apparatus to train a model using federated learning, the apparatus including interface circuitry to access the model; and processor circuitry including one or more of at least one of a central processing unit, a graphic processing unit or a digital signal processor, the at least one of the central processing unit, the graphics processor unit or the digital signal processor having control circuitry to control data movement within the processor circuitry, arithmetic and logic circuitry to perform one or more first operations corresponding to instructions, and one or more registers to store a result of the one or more first operations, the instructions in the apparatus; a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or Application Specific Integrate Circuitry (ASIC) including logic gate circuitry to perform one or more third operations; the processor circuitry to perform at least one of the first operations, the second operations or the third operations to instantiate: neural network trainer circuitry to generate model updates for the model; and federated learning accelerator management circuitry to cause an accelerator to transmit the model updates to an aggregator device.

Example 38 includes the apparatus of example 37, wherein the federated accelerator management circuitry to cause the accelerator to one of encrypt or embed data used to generate the model updates.

Example 39 includes the apparatus of examples 38 or 39, wherein the federated accelerator management circuitry is to cause the accelerator to encrypt or embed the data in response to the interface circuitry accessing the model.

Example 40 includes the apparatus of any of examples 37-39, wherein the federated accelerator management circuitry to cause the accelerator to filter data used to generate the model updates.

Example 41 includes a method for federated training of a neural network at an edge device of an edge system, the method including causing a federated learning accelerator to perform a workload associated with generating a model update; training the neural network to generate the model update using local data associated with the edge device; and causing the model update to be transmitted to an aggregator device in the edge system.

Example 42 includes the method of any of examples 37-41, further including causing the federated learning accelerator to one or more of encrypt or filter the local data.

Example 43 includes the method of any of examples 37-42, further including identify the workload as a workload to be performed by the federated learning accelerator based on a trigger event for initiating the workload.

Example 44 includes the method of any of examples 37-43, wherein the trigger event includes receipt of a machine learning model by the edge device.

Example 45 includes the method of any of examples 37-44, wherein the trigger event includes generation of the model update.

Example 46 includes the method of any of examples 37-45, further including causing the federated learning accelerator to transmit the model update.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

The status of the claims:

1. An edge device comprising:
neural network trainer circuitry to train a neural network to generate a model update for a machine learning model using local data;
a federated learning accelerator to perform one or more federated learning workloads associated with the training; and
model update provider circuitry to transmit the model update to an aggregator device.

2. The edge device of claim 1, wherein the federated learning accelerator includes the model update provider circuitry.

3. The edge device of claim 1, wherein the federated learning accelerator includes data encrypter circuitry to encrypt the local data.

4. The edge device of claim 1, further including federated learning accelerator management circuitry to generate instructions to cause the federated learning accelerator to perform the one or more federated learning workloads.

5. The edge device of claim 4, wherein the federated learning accelerator management circuitry includes federated learning accelerator interface circuitry.

6. The edge device of claim 4, wherein the federated learning accelerator management circuitry includes workload analyzer circuitry to identify a workload to be performed by the federated learning accelerator.

7. The edge device of claim 1, further including model receiver circuitry to receive the machine learning model from the aggregator device.

8. The edge device of claim 1, wherein the federated learning accelerator learning accelerator is to perform one or more data processing operations based on at least one of a data format associated with the local data, a data type associated with local data, or a data sparsity level associated with the local data.

9. At least one non-transitory computer readable storage medium comprising instructions that, when executed, cause processor circuitry of a training device in an edge system to at least:
cause a federated learning accelerator to perform a workload associated with generating a model update;
train a neural network to generate the model update using local data associated with the training device; and
cause the model update to be transmitted to an aggregator device in the edge system.

10. The at least one non-transitory computer readable storage medium of claim 9, wherein the instructions, when executed, are to cause the federated learning accelerator to one or more of encrypt or filter the local data.

11. The at least one non-transitory computer readable storage medium of claim 9, wherein the instructions, when executed, cause the processor circuitry to identify the workload as a workload to be performed by the federated learning accelerator based on a trigger event for initiating the workload.

12. The at least one non-transitory computer readable storage medium of claim 11, wherein the trigger event includes receipt of a machine learning model by the training device.

13. The at least one non-transitory computer readable storage medium of claim 11, wherein the trigger event includes generation of the model update.

14. The at least one non-transitory computer readable storage medium of claim 9, wherein the instructions, when executed, cause the processor circuitry to cause the federated learning accelerator to transmit the model update.

15. An apparatus comprising:
at least one memory;
instructions in the apparatus; and
processor circuitry to execute the instructions to:
train a neural network to generate a model update for a machine learning model using local data associated with a training device in an edge system;
perform one or more federated learning workloads associated with the training; and
transmit the model update to an aggregator device in the edge system.

16. The apparatus of claim 15, wherein the processor circuitry is to perform a first federated learning workload to encrypt the local data.

17. The apparatus of claim 16, wherein the processor circuitry is to perform a second federated learning workload to filter the local data.

18. The apparatus of claim 15, wherein the processor circuitry is to identify a workload to be performed as the one or more federated learning workloads based on a trigger event for initiating the workload.

19. The apparatus of claim 18, wherein the trigger event includes receipt of the machine learning model by the training device.

20. The apparatus of claim 18, wherein the trigger event includes generation of the model update.

21.-46. (canceled)
